(19) United States
(12) Patent Application Publication
(10) Pub. No.: US 2006/0011026 A1
(43) Pub. Date: Jan. 19, 2006

(54) Ergonomic, handheld, power index punch

(76) Inventor: Mark Dickey, Sandy, UT (US)

Correspondence Address: Kirton & McConkie, 1800 Eagle Gate Tower, 60 East South Temple, Salt Lake City, UT, 84111, US

(21) Appl. No.: 10/892,388

(22) Filed: Jul. 15, 2004

(51) Int. Cl. B26D 1/00; B26F 1/14

(52) U.S. Cl. 83/13; 83/684

(57) ABSTRACT

A power index punch for cutting notches in the fore edge of a book is disclosed in one aspect of the present invention as including a cutting die having a cutting edge forming a substantially closed channel. A vacuum mechanism is used to create a vacuum within the closed channel to remove cuttings produced by the cutting die. A cutting plate is adapted to contact the cutting die to provide a surface for the cutting die to cut against. Both the cutting die and the cutting plate are openly visible to an operator of the index punch to facilitate manual adjustment of the cutting die with respect to a material being cut.

### BACKGROUND OF THE INVENTION

1. Field of the Invention

The present invention relates to apparatus and methods for indexing written materials. In particular, the present invention relates to systems and methods for cutting “thumb indexes” into the pages of written materials.

2. Background and Related Art

To aid in the navigation of books and other written materials, various indexing schemes have been developed to facilitate the finding and retrieval of information. For example, tabs or other related indexing means have been used extensively to provide a quick and convenient way to find information without having to open a book to the table of contents or index. Likewise, an indexing scheme known as a “thumb index” has also been used to quickly locate information. A thumb index is generally created by cutting notches into the pages of the fore edge of a book at selected locations. When a reader desires to access a particular section of a book, the reader may quickly peruse the thumb index before opening the book. When the desired section is located, the reader may quickly access the section by placing a finger in the desired notch while simultaneously opening the book. Because of the relatively compact and elegant solution they provide, thumb indexes have been commonly used to index reference materials, such as dictionaries, encyclopedias, and bibles.

Nevertheless, the process of cutting thumb indexes into books presents certain challenges. For example, because a book's fore edge is typically planar and perpendicular to the front and rear covers, thumb index notches typically protrude into the fore edge at an angle. This angled notch must be cleanly cut to the desired section without cutting into pages of the section. Because most paper cutting devices are designed to cut paper perpendicularly, unique apparatus and methods are needed to generate an angled notch through numerous sheets of paper.

Likewise, because the notches typically traverse numerous pages, a large quantity of cuttings may be produced upon slicing the notches. If not properly removed, these cuttings may jam or interfere with a cutting device. This may cause the cutting device to fail or may result in a ragged cut which may ruin a book or render it a blemished product of reduced value. Thus, the ability to effectively remove cuttings is important not only to make the notch-cutting process efficient, but also to minimize waste by reducing the number of ruined or blemished products.

The notches, the process of creating thumb indexes are generally not fully automated, but require significant manual intervention. For example, in some instances, a skilled operator may need to manually position a cutting device with respect to the pages of a book before cutting the notches. Thus, a cutting device should be easily manipulated by an operator and easily aligned with the appropriate pages of a book before cutting. Moreover, because of the repetitive nature of the cutting process, a cutting device should be one that minimizes corporal stress on the operator.

Accordingly, what are needed are apparatus and methods for effectively and efficiently cutting notches, even angled notches, into the fore edge of books. Likewise, apparatus and methods are needed to effectively remove cuttings from the work area and cutting equipment during the cutting process. Finally, what are needed are apparatus that are easily manipulated by and minimize stress on an operator thereof.

### SUMMARY OF THE INVENTION

The present invention relates to apparatus and methods for cutting angled notches, such as “thumb indexes,” into the fore edge or other surface of a book or volume. The present invention further relates to apparatus and methods for effectively removing cuttings from the work area and cutting equipment during the cutting process. Finally, the present invention relates to cutting apparatus that are easily manipulated and minimize corporal stress on an operator.

Consistent with the foregoing, and in accordance with the invention as embodied and broadly described herein, a power index punch for cutting notches in the fore edge of a book is disclosed in one aspect of the present invention as including a cutting die having a cutting edge forming a substantially closed channel. A vacuum mechanism is used to create a vacuum within the closed channel to remove cuttings produced by the cutting die. A cutting plate is adapted to contact the cutting die to provide a surface for the cutting die to press against. Both the cutting die and the cutting plate are openly visible to an operator of the index punch to facilitate manual adjustment of the cutting die with respect to a material being cut.

In another aspect of the invention, a method for cutting rounded notches in the fore edge of a book includes providing a cutting die having a cutting edge forming a substantially closed channel. The method further includes creating a vacuum within the closed channel to remove cuttings produced by the cutting die. Additionally, the method includes providing a cutting plate adapted to contact the cutting die. Both the cutting die and cutting plate are openly visible to an operator thereof to facilitate manual adjustment of the cutting die with respect to a material being cut.

In yet another aspect of the invention, an apparatus for cutting rounded notches in the fore edge of a book includes a cutting die having a cutting edge forming a substantially closed channel. A vacuum mechanism is used to create a vacuum within the closed channel to remove cuttings produced by the cutting die. A cutting plate is adapted to contact the cutting die and a curved ergonomic handle is provided to facilitate handling of the apparatus

A linear activating pneumatic ram is used to force the die against the cutting plate to slice or shear the pages. By using a direct connection between the ram and the die, the length of stroke can be precisely controlled. This is important since the die must cut through the last page and contact the plate with precisely the pressure needed to cut through the last page but not hit the plate with enough force to hurt the die.

While the methods and processes of the present invention have proven to be particularly useful for punching index notches into printed materials, such as books, those skilled in the art can appreciate that the methods and processes can be used in a variety of different applications and in a variety of different areas of manufacture to punch or modify various materials.

These and other features and advantages of the present invention will be set forth or will become more fully apparent in the description that follows and in the appended claims. The features and advantages may be realized and obtained by means of the elements and combinations particularly pointed out in the appended claims. Furthermore, the features and advantages of the invention may be learned by practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a perspective view of one embodiment of a pneumatic index punch in accordance with the invention;

FIG. 2 is a side profile view of one embodiment of a pneumatic index punch in accordance with the invention;

FIG. 3 is a perspective view illustrating one aspect of notches, such as a “thumb index,” that may be cut or punched by an index punch in accordance with the invention;

FIG. 4A is a side profile view of one embodiment of a notch cut into a book or other bound volume;

FIG. 4B is a side profile view of one embodiment of a notch cut into a book or other bound volume, wherein the book is temporarily leaned away from perpendicular; and

FIG. 5 is side profile view of one embodiment of an index punch in the course of operation.

### DETAILED DESCRIPTION OF THE INVENTION

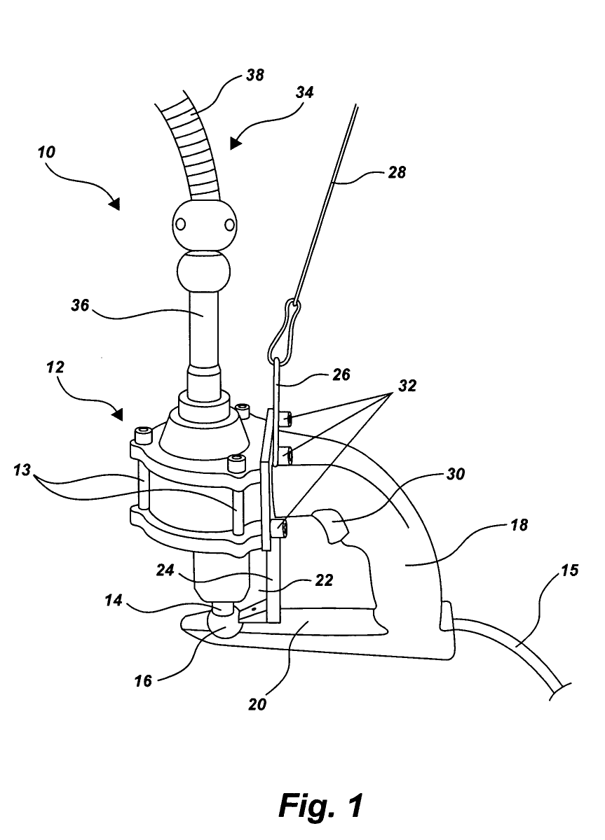

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 5, is not intended to limit the scope of the invention, as claimed, but it is merely representative of the presently preferred embodiments of the invention.

The presently preferred embodiments of the invention will be best understood by reference to the drawings, wherein like parts are designated by like numerals throughout. Those of ordinary skill in the art will, of course, appreciate that various modifications to the details illustrated in FIGS. 1 through 5 may easily be made without departing from the essential characteristics of the invention. Thus, the following description is intended only as an example, and simply illustrates one present embodiment consistent with the invention as claimed herein.

Referring to FIG. 1, in one aspect of the invention, a power index punch 10 in accordance with the invention includes a housing 12 adapted to contain a driving means (not shown) to power the device 10. The housing 12 may be constructed of several pieces held together by fastening means 13, or may be a single integrated component. Although a pneumatic powered embodiment is illustrated, the driving means may also be provided by other alternative means including but not limited to a solenoid, a combustion chamber, or a biasing member, such as a spring or elastomeric material. In pneumatic embodiments of the device 10, an air hose 15 may be used to route compressed air to the device 10. Likewise, in electrical embodiments, a power cord 15 may provide electricity to the device 10. The driving means is operably connected to a cutting die 14 adapted to cut or punch a suitable material, such as paper, wood, rubber, cardboard, cloth, metal, plastic, composite, polymer, or some other suitable sheet-like material. The cutting die 14 may contact a cutting plate 16. The cutting plate 16 provides a surface for the cutting die 14 to cut against and may be constructed of any suitable material. In selected embodiments, the material used to construct the cutting plate 16 may be softer than that used to construct the cutting die 14. This may prevent or reduce excessive dulling or damage to the cutting die 14.

The power index punch 10 may also include a handle portion 18 and a foot 20 defining a tool throat 22. Depending on the application, dimensions of the throat 22 may be adjusted to accommodate materials of varying dimensions. In selected applications, if only a shallow throat is needed, a support 24 may be provided to provide structural support to the index punch 10. In selected embodiments, the handle portion 18 may have a curved ergonomic contour so the tool 10 may be comfortably handled and minimize corporal stress on an operator. Additionally, in selected embodiments, the index punch 10 may include an optional support bracket 26 to accommodate an overhead support 28, such as a cable 28, to sustain all or a portion of the weight of the tool 10. The handle 18 may also include a trigger 30 to control the operation of the index punch 10. In selected embodiments, the handle 18 may include fastening means 32 to connect the handle to the housing 12. In other embodiments, the handle 18 and housing 12 may be integrated into a single component.

When the cutting die 14 punches or cuts a desired material, cuttings or waste materials are created. Accordingly, apparatus and methods are needed to remove these cuttings from the cutting area to keep the work area free of debris, to prevent jamming or interference with the tool 10, and to prevent damage to the material being cut or punched. Thus, in selected embodiments, a vacuum mechanism (not shown) may be provided to remove cuttings through a vacuum channel 34. Although not mandatory, in selected embodiments, the vacuum channel may be characterized by a rigid portion 36 and a flexible portion 38.

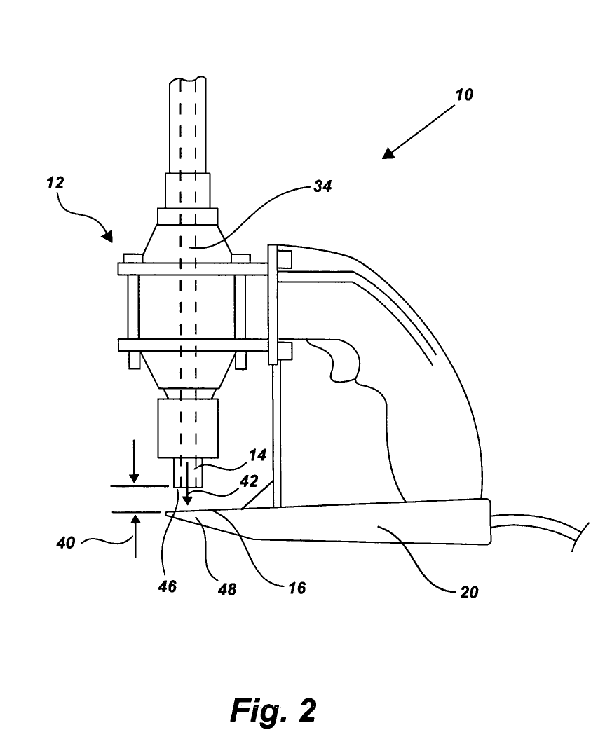

Referring to FIG. 2, the cutting die 14 may be characterized by a throw length 40 and a throw direction 42. Because of the impact or contact that occurs between the cutting die 14 and the cutting plate 16, proper adjustment of the throw length 40 may be an important concern. If the throw length is too long, the impact or force exerted by the cutting die 14 on the cutting plate 16 may be excessive, and may unnecessarily dull or damage the cutting die 14 or cutting plate 16. If the throw length is too short, the cutting die may not contact or sufficiently near the cutting plate 16 in order to effectively punch or cut through a selected material. Thus, proper adjustment of the throw length 40 may be an important issue.

As illustrated, the vertical symmetry of the housing 12 is substantially parallel to the throw direction 42 of the cutting die 14. Because the housing 12 may contain a ram or other driving means to drive the cutting die 14, the ram or driving means may also be substantially parallel to the cutting die 14. This configuration is efficient because mechanical energy is more readily transferred from the ram or driving means to the cutting die 14 and less mechanical energy is lost inside the index punch 10 than might be lost with a horizontally mounted ram. Thus, a straight ram may be more efficient and thus may potentially provide a lighter, more reliable solution. In addition, because the ram or driving means is parallel to the cutting die 14, the throw length 40 may be adjusted or optimized more easily by adjusting the travel of the ram or driving means, or by adjusting the relationship between the cutting die 14 and the ram or driving means.

Likewise, a straight ram may more readily accommodate a vacuum channel 34 traveling parallel to the ram and the cutting die 14 because the channel 34 may be routed along a straight path. As illustrated, the vacuum channel 34 travels through the cutting die 14 and housing 12. Cuttings or other waste produced by the cutting die 14 may be sucked into the vacuum channel 34 away from the cutting area. Nevertheless, although a straight ram may be desirable in selected embodiments, the invention is not limited to straight-ram configurations, but in some cases may use a horizontally mounted or other configuration.

Although notches, such as thumb indexes, typically have a semi-circular or arcuate shape, the cutting edge 46 of the cutting die 14 may form a closed channel such as a circle or other rounded shape. This may provide several advantages. First, a closed channel may make the vacuum mechanism more effective by reducing vacuums leaks. This may increase the vacuum within the channel 34 and improve the removal of cuttings or other waste materials. Similarly, because the cutting die 14 forms a closed channel, such as a circle, the cutting die 14 may be rotated when one side of the die 14 becomes dull or damaged. Likewise, a die 14 that forms a closed channel may reduce or eliminate the need to properly orient the die 14 with respect to a material being cut, whereas a semi-circular or other open channel configuration would need to be properly oriented with respect to the material. Also, because the index punch 10 may be used to cut notches through numerous layers of paper, the foot 40 may include a wedge shaped portion 48 to easily slip between pages of printed material, while retaining enough structural integrity to resist the force of the cutting die 14 as it contacts a material being cut or the cutting plate 16.

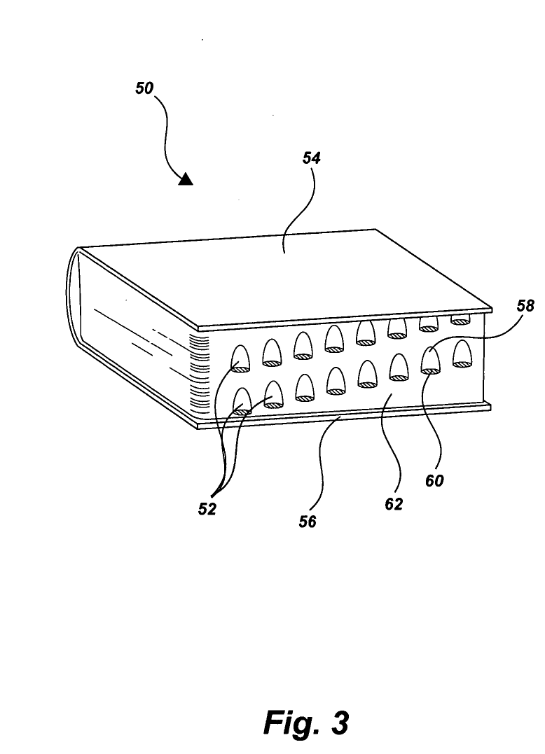

Referring to FIG. 3, a bound volume 50 indexed with multiple notches 52 (i.e., a “thumb index”) is illustrated. As shown, the notches 52 may be arranged in an inclined or slanted pattern along the fore edge 62 to index various sections of the volume 50. In selected embodiments, each notch 52 may narrow at the top 58, where the notch 52 is relatively shallow, and widen at the bottom 60, where the notch 52 is deeper. Indexing information, such as an abbreviation of a section name, a chapter name, a page number, an alphabetical character, or the like, may be printed on the page defining the notch bottom 60. The pattern of notches 52 illustrated in FIG. 3 is presented merely by way of example and is not intended to limit the scope of the present invention. In actuality, the notches 52 may be arranged in wide variety of different patterns and may have varying heights, depths, widths, shapes, or the like.

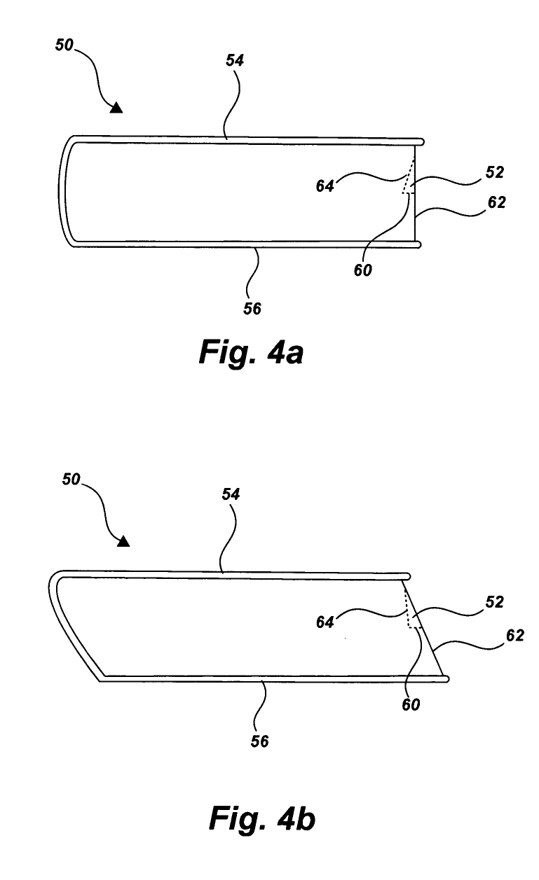

Referring to FIG. 4A, normally, when at rest, the fore edge 62 of a volume 50 forms a substantially right angle with respect to the front and back covers 54, 56. Likewise, the fore edge 62 generally forms a substantially right angle with respect to the bottom 60 of a notch 52. Conversely, because a notch 52 typically cuts into the fore edge 62 at an angle, the back 64 and bottom 60 of the notch 52 generally form an acute angle, or an angle that is less than ninety degrees. Since most cutting dies typically create a cut wherein the bottom of the cut forms a substantially right angle with respect to the sides of the cut, creating an angled notch 52 may appear to be problematic on its face. Thus, unique apparatus or methods are needed to cut angled notches into the fore edge of books 50 or other volumes 50.

Referring to FIG. 4B, in selected embodiments, a book 50 or volume 50 may be temporarily deformed such that the fore edge 62 no longer forms a right angle with respect to the front and back covers 54, 56. Likewise, the notch 52 (or the space accommodating a proposed notch 52) may also be deformed until the proposed back 64 of the notch 52 is substantially perpendicular to the proposed bottom 60 of the notch 52. Since the back 64 and bottom 60 form a right angle, or substantially a right angle, a notch 52 may be more easily cut using a conventional cutting die 14 or other cutting or punching device. Once the notch 52 is formed, the book 50 may be returned to its original shape as illustrated in FIG. 4A.

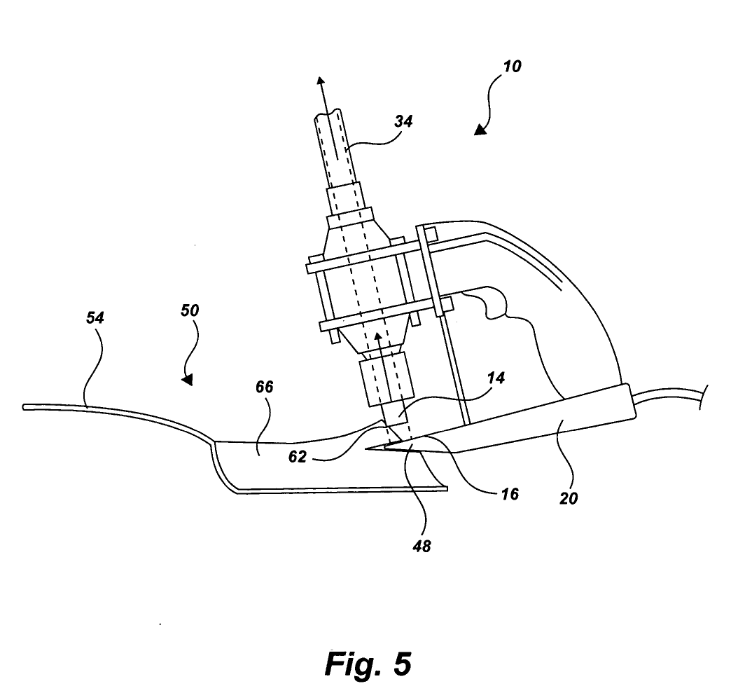

Referring to FIG. 5, in operation, a book 50 or volume 50 may be temporarily deformed as illustrated in FIG. 4B. In some cases the front cover 54 may be folded back to keep it from interfering with the index punch 10 and to expose the pages 66 for punching or cutting. The foot 20 is then inserted between pages 66 marking the boundary between desired sections of the book 50. As was previously explained, the foot 20 holds the cutting plate 16 which provides a surface for the cutting die 14 to cut against. The wedge shape 48 of the foot 20 also allows the foot 20 to easily slip between pages 66 while maintaining sufficient structural integrity for the cutting dies 14 to cut against. Because of the deformed state of the book 50, the cutting die 14 may cut into the fore edge 62 of the book 50 and cleanly cut the pages 66 against the cutting plate 16. The paper cuttings are then carried up through the cutting die 14 through the vacuum channel 34. Also, since the index punch 10 is manually operated, the openly accessible and visible nature of the cutting die 14, foot 20, and cutting plate 16, allows the tool 10 to be easily adjusted and positioned with respect to a book 50.

Thus, as discussed herein, the embodiments of the present invention embrace a novel index punch 10. The index punch 10 has been developed in response to long felt need for a tool that is lightweight, ergonomic, and easily manipulated by an operator, provides visibility of the material being cut, is openly accessible, removes cuttings from the cutting area, and is efficient. As was previously mentioned, although the index punch 10 described herein is a pneumatic punch, in actuality, the punch 10 may be powered by any suitable means.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. An apparatus for cutting notches in the fore edge of pages of a book, the apparatus comprising:
a cutting die having a cutting edge forming a substantially closed channel;
a vacuum mechanism creating a vacuum within the closed channel, wherein the vacuum mechanism is adapted to remove cuttings produced by the cutting die; and
a cutting plate adapted to contact the cutting die, wherein the cutting die and cutting plate are openly visible to an operator thereof to facilitate manual adjustment of the cutting die with respect to a material being cut.

2. The apparatus of claim 1, wherein the cutting edge is characterized by a substantially rounded contour.

3. The apparatus of claim 1, wherein the cutting edge is substantially circular.

4. The apparatus of claim 1, wherein the apparatus is handheld.

5. The apparatus of claim 4, further comprising a curved ergonomic handle to facilitate handling of the apparatus.

6. The apparatus of claim 5, wherein the cutting die is characterized by a throw direction and the handle is aligned at a substantially non-parallel angle with respect to the throw direction.

7. The apparatus of claim 1, wherein the cutting die is characterized by a throw direction and wherein the cutting die is driven by a ram moving in a direction substantially parallel to the throw direction.

8. The apparatus of claim 7, wherein the ram is driven by a power source selected from the group consisting of a pneumatic device, a solenoid, a combustion device, and a biasing element.

9. The apparatus of claim 1, wherein the cutting die is characterized by a throw length and wherein the throw length is adjustable.

10. The apparatus of claim 1, wherein the material is the fore edge of a book

11. A method for cutting notches in the fore edge of pages of a book, the method comprising:
providing a cutting die having a cutting edge forming a substantially closed channel;
creating a vacuum within the closed channel, wherein the vacuum is adapted to remove cuttings produced by the cutting die; and
providing a cutting plate adapted to contact the cutting die, wherein the cutting die and cutting plate are openly visible to an operator thereof to facilitate manual adjustment of the cutting die with respect to a material being cut.

12. The method of claim 11, wherein the cutting edge is characterized by a substantially rounded contour.

13. The method of claim 11, wherein the cutting edge is substantially circular.

14. The method of claim 1 1, further comprising providing a curved ergonomic handle to facilitate handling of the cutting die and the cutting plate.

15. The method of claim 14, wherein the cutting die is characterized by a throw direction and the handle is aligned at a substantially non-parallel angle with respect to the throw direction.

16. The method of claim 11, wherein the cutting die is characterized by a throw direction and wherein the cutting die is driven by a ram moving in a direction substantially parallel to the throw direction.

17. The method of claim 16, wherein the ram is driven by a power source selected from the group consisting of a pneumatic device, a solenoid, a combustion device, and a biasing element.

18. The method of claim 11, wherein the cutting die is characterized by a throw length and wherein the throw length is adjustable.

19. The method of claim 11, wherein the material is the fore edge of a book

20. An apparatus for cutting rounded notches in the fore edge of a book, the apparatus comprising:
a cutting die having a cutting edge forming a substantially closed channel;
a vacuum mechanism creating a vacuum within the closed channel, wherein the vacuum mechanism is adapted to remove cuttings produced by the cutting die;
a cutting plate adapted to contact the cutting die; and
a curved ergonomic handle to facilitate handling of the apparatus.
